(19) United States
(12) Patent Application Publication
(10) Pub. No.: US 2007/0173158 A1
(43) Pub. Date: Jul. 26, 2007

(54) High elasticity polyester wetsuit fabric and method of fabrication thereof

(75) Inventor: Min-Chen Shiue, I-Lan Hsien (TW)

Correspondence Address: Leonard Tachner,;A Professional Law Corporation, Suite 38-E, 17961 Sky Park Circle, Irvine, CA, 92614, US

(73) Assignee: Shei Chung Hsin Ind. Co., Ltd

(21) Appl. No.: 11/338,086

(22) Filed: Jan. 24, 2006

(51) Int. Cl. B32B 5/18; D04B 21/14; D04B 1/22

(52) U.S. Cl. 442/306; 442/312; 442/315

(57) ABSTRACT

A wetsuit fabric is knitted from fine denier, high count polyester yarn and fine denier, high elongation elastic yarn using a circular knitting machine under a high gauge setting, dyed and finished to form a high density wetsuit fabric. This fabric is laminated with a rubber sponge material to form an improved high elasticity polyester wetsuit fabric which is especially Velcro-hook resistant.

### BACKGROUND OF THE INVENTION

1. Field of the Invention

The present invention relates generally to the field of wetsuits used for diving, surfing and the like, and more specifically to an improved wetsuit fabric that is knitted from fine denier and high count polyester yarn and fine denier and high elongation elastic yarn using a circular knitting machine with high gauge knit setting dyed and completed in a finishing process to form the high density polyester wetsuit fabric.

2. Background Art

The prior art that appears to be most relevant to the present invention is applicant's commonly owned U.S. Pat. No. 6,708,528 issued Mar. 23, 2004 to Chuang. This patent discloses a high-elasticity wetsuit fabric knitted with fine nylon fibers and elastic fibers and then laminated to one or both surfaces of an artificial rubber sponge material. Although this high density, high elastic wetsuit fabric has many advantageous features in comparison to more conventional wetsuit fabrics, it has the disadvantage of being susceptible to damage from a Velcro hook material coming in contact with the fabric and pulling individual nylon/elastic threads out of the knitted fabric.

It would be highly advantageous if it were possible to achieve the unique elasticity and comfort of the fabric disclosed in the '528 patent in a knitted configuration that was more resistant to the effects of contact with Velcro hook material which is in common use in conjunction with wetsuits and related diving equipment.

### SUMMARY OF THE INVENTION

The present invention relates to an improved wetsuit fabric that is knitted from fine denier and high count polyester yarn and fine denier and high elongation elastic yarn using a circular knitting machine with high gauge knit setting to form the high density polyester wetsuit fabric. Then, this fabric is laminated with a rubber sponge to form the invention, an improved high elasticity polyester wetsuit fabric. Compared with the convention stretch nylon fabric, the invention offers the wetsuit wearer softer, smoother, more flexible and greater comfort and is especially Velcro-hook resistant. The polyester yam, mentioned above, is specified below 75 denier since the yarn which is below 75 denier can make the fabric lighter and thinner, and make the surface of the wetsuit smoother and more Velcro-hook resistant. After being knitted with elastic yarn, which is below 30 denier, it offers the capability of high elongation and high recovery, to form the improved polyester wetsuit fabric with a better capability of high elongation, density, and elasticity and is more Velcro-hook resistant.

The polyester yarn and elastic yarn are fed simultaneously into the knitting machine which is set to a weight of 150-210 gram/yard and a width of 54-60 inches for the high elastic fabric.

The high elastic polyester fabric is knitted by the machine with at least 30 gauge/per inch to make the fabric high density and achieve the capability of Velcro-hook resistance and provide the laminated finished product the capability of substantial elongation.

The finished high elastic fabric is at a weight of 150-210 gram/yard, a width of 54-60 inches, and the elongation capability in both the vertical and horizontal directions is greater than 200%.

Then this high elastic polyester fabric is laminated with a rubber sponge material in selected thicknesses on either one side or two sides by glue to form the improved high elastic polyester wetsuit fabric hereof.

Compared with conventional stretch nylon wetsuit fabric, the polyester wetsuit fabric of the present invention offers excellent performance and the capability of high elongation, high density and high elasticity. It is believed to be the first time for wetsuit fabric to be made of rubber sponge laminated with the high elastic polyester fabric, which is Velcro-hook resistant, using a high density knitting process and made of polyester and elastic yarn.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional drawing of a step in the process of fabricating a wetsuit fabric wherein a highly elastic, high-density polyester fabric is glued to a rubber sponge material;

FIG. 2 is a three-dimensional drawing of another step wherein the stretch fabric is also adhered to the opposing surface of the rubber sponge material;

FIG. 3 illustrates the tendency of conventional, prior art wetsuit fabrics to be damaged by Velcro hooks; and

FIG. 4 illustrates the Velcro hook resistance of the inventive wetsuit fabric.

### DETAILED DESCRIPTION OF A PREFERRED EMBODIMENT

The improved wetsuit fabric of the present invention overcomes the Velcro hook susceptibility of the nylon fabric of the '528 disclosure. This is accomplished by substituting a finer polyester yarn (70 versus 100 denier) for the nylon yarn of the '528 fabric.

The method for production of high-elasticity wetsuit fabric in accordance with the present invention is divided into two phases: (1) manufacturing high-elasticity wetsuit fabric; and (2) lamination of artificial rubber sponge.

Phase I: Manufacturing High-Elasticity Wetsuit Fabric

The high-elasticity wetsuit fabric of the present invention is made of fine count polyester fibers with fine denier counts of elastic yarns with high elongation and recovery capabilities, and has a texture designed on the basis of elastic features. Such a fabric is knitted with a circular knitting machine, with high gauge knit setting, and treated in a dyeing and finishing process.

The yarn used in the aforementioned process is made of polyester fibers having a specification below 70 deniers. The fine yarn below 70 deniers is light in weight and capable to reduce absorbency of fabrics. The fabric made under such conditions is thinner and has a better Velcro-hook resistance capability, a smoother surface and an excellent breakage strength. Having been knitted with elastic yarn having a specification below 30 deniers and high elongation and recovery capabilities, the wetsuit fabric of the present invention has a high elongation capability and a high density as the basis for the high Velcro-hook resistance capability.

In the aforementioned process, a plain knit is designed to give the wetsuit fabric a highest elongation capability. The polyester fibers and elastic yarn are fed simultaneously with each feeder of the loom. The knitting machine is readjusted to a 150 to 210 gram/yard ratio for the gray cloth and the gray cloth is 54 to 60 inches in the breadth.

Such a fabric is knitted with a loom having a needle size 30 gauge or more, so as to create a high knitting density, reach the expected Velcro-hook resistance level and bring an excellent elongation to laminated finished products. In the knitting process, the tension of the polyester yarns and the elastic yarn are appropriately controlled, and a higher tension of the lower fabric is applied to the loom to make the surface of the fabric, having a high content of elastic yarn, smooth and produce an excellent touch and a good Velcro-hook resistance effect.

After being dyed, tentered and otherwise treated in the process, the gray cloth of the high-elasticity wetsuit fabric is in the 150 to 210 gram/yard ratio and is 54 to 60 inches in the breadth, and the elastic elongation in both the vertical and horizontal directions is more than 200%.

The high-elasticity fabric 20 of the present invention is produced in the aforementioned process.

Phase II: Lamination of Artificial Rubber Sponge

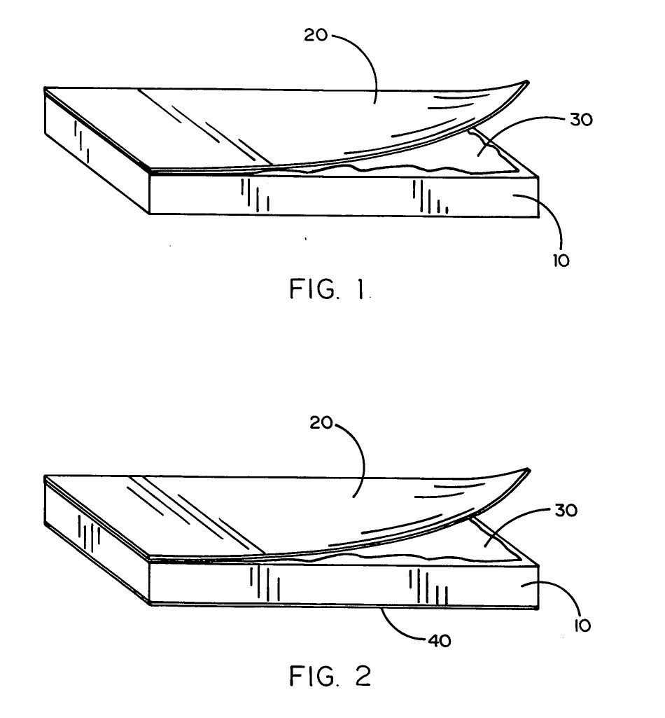

In a lamination process, the wetsuit fabric of the present invention 20 is laminated with an artificial rubber sponge 10. The thickness of the artificial rubber sponge 10 can be any of a plurality of thicknesses. As shown in FIGS. 1 and 2, the wetsuit fabric is capable of being laminated on one single side or both sides with a glue binder 30, respectively. The laminated fabric is then made to be a wetsuit fabric piece with high elasticity at a special elasticity-processing stage.

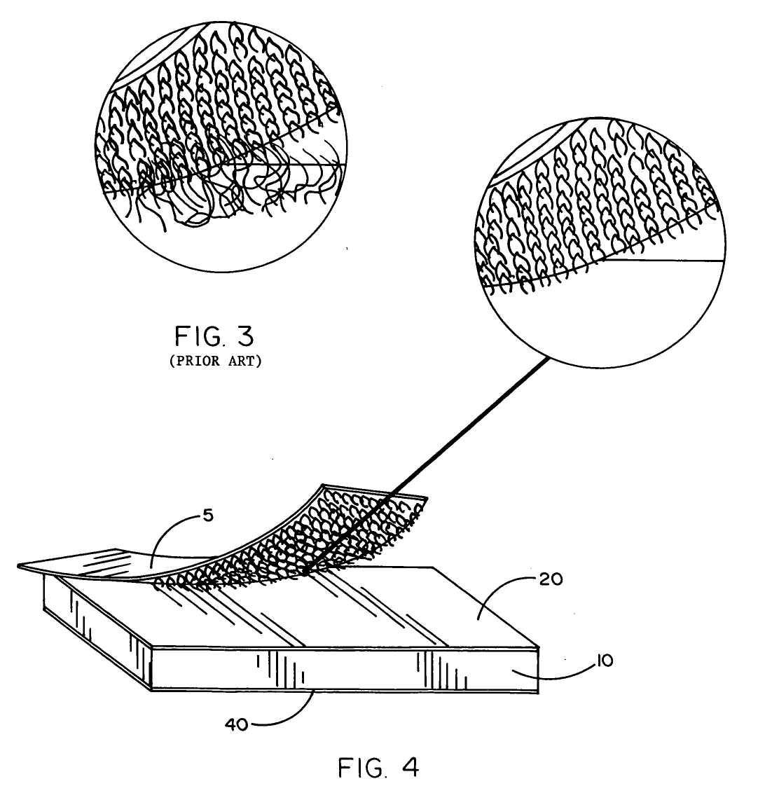

The present invention is better in performance than the conventional stretch nylon wetsuit fabric, especially in the aspects of the elastic elongation, low modulus, low absorbency and high velcro-hook resistance capability. In the application to professional wetsuits, the present invention is more comfortable, flexible and fitted for wearers in comparison with conventional stretch nylon wetsuit fabrics, and is capable to provide higher value in industrial applications. Most significantly, the wetsuit fabric hereof has all of the advantageous features of the fabric disclosed in applicant's '528 patent disclosure, but with the added and surprising additional benefit of resistance to Velcro-hook material 5 with which it is likely to come in contact as shown in FIGS. 3 and 4.

Although the structure and uniqueness of the present invention have been illustrated and described with reference to the preferred embodiment thereof, it should be understood that it is in no way limited to the details of such embodiment, but is capable of numerous modifications within the scope of the appended claims and their equivalents.

I claim:

1. An improved wetsuit fabric knitted from fine denier and high count polyester yarn and fine denier and high elongation elastic yarn by using a circular knitting machine with high gauge knitting.

2. The wetsuit fabric recited in claim 1 treated in dyeing and related finishing to form a high-density wetsuit fabric.

3. The wetsuit fabric recited in claim 1 laminated with a rubber sponge.

4. The wetsuit fabric of claim 1 wherein the polyester yarn is below 70 denier.

5. The wetsuit fabric of claim 1 wherein the elastic yarn is below 30 denier.

6. The wetsuit fabric recited in claim 1 having a weight of 150-210 gram/yard, a width of 54-60 inches, and wherein the elongation in both the vertical and horizontal direction is more than 200%.

7. A knitting process for making a wetsuit fabric, the process comprising the step of feeding a polyester yarn and an elastic yarn simultaneously into a knitting machine which is set to a weight of 150-210 gram/yard and a width of 54-60 inches.

8. The knitting process recited in claim 7 comprising the step of setting said knitting machine with at least 30 gauge/per inch to make the fabric with smooth and high density.

9. A high-elasticity wetsuit fabric made of fine count polyester fibers with fine denier count elastic yarns with high elongation and recovery capabilities, knitted with a high-speed circular knitting machine and treated in a dyeing and finishing process, said high-elastic wetsuit fabric being laminated with an artificial rubber sponge in a laminating process, the fabric comprising:
a wetsuit fabric made of polyester fibers having a fineness less than 70 deniers and knitted with elastic fibers having a fineness less than 30 deniers, the knit being designed to maximize an elongation capability of the wetsuit fabric, said polyester fibers and elastic fibers being fed simultaneously with respective feeders of a loom, said loom being adjusted to a 150-210 gram/yard ratio and said wetsuit fabric being 54-60 inches in breadth, said wetsuit fabric being woven with said loom having needles of at least 30-gauge, after being dyed, shaped and otherwise treated, said wetsuit fabric having an elastic elongation capability in both vertical and horizontal directions of more than 200%; and
an artificial rubber sponge having a predetermined thickness on which the high-elastic fabric is laminated, a binder being applied between said wetsuit fabric and said artificial rubber sponge to form a laminated high-elasticity fabric piece.

10. The high-elasticity wetsuit fabric as claimed in claim 9, wherein said wetsuit fabric is laminated to one single side of said artificial rubber sponge.

11. The high-elasticity wetsuit fabric as claimed in claim 9, wherein said wetsuit fabric is laminated to both front and reverse sides of said artificial rubber sponge.
